(19) United States
(12) Patent Application Publication
(10) Pub. No.: US 2013/0147441 A1
(43) Pub. Date: Jun. 13, 2013

(54) Automatic Tuning Method for Energy Storage System of Railway Vehicle

(71) Applicants: Eun-Kyu LEE, Cheongju-Si (KR); Tae-Suk Kim, Cheongju-Si (KR); Kyoung-Min Kwon, Jeungpyeong-Gun (KR)

(72) Inventors: Eun-Kyu LEE, Cheongju-Si (KR); Tae-Suk Kim, Cheongju-Si (KR); Kyoung-Min Kwon, Jeungpyeong-Gun (KR)

(21) Appl. No.: 13/419,471

(22) Filed: Mar. 14, 2012

(30) Foreign Application Priority Data
Dec. 12, 2011 (KR) 10-2011-0132708

(51) Int. Cl. H02J 7/00

(52) U.S. Cl. 320/167

(57) ABSTRACT

An automatic tuning method is developed for an energy storage system of the railway vehicle. The method comprises; an optimal tracking for voltage fluctuation in the overhead line voltage varying with hourly-basis, the voltage variation of the substation and railway vehicle operating pattern. The railway vehicle is automatically performed the tuning to maximize the energy storing efficiency. The railway vehicle can achieve the optimum operation for saving energy effectively by bidirectional DC/DC converter using regenerative energy of DC. The railway vehicle stably operates under the overhead line voltage fluctuation. The energy efficiency is maximized by charging/discharging energy while the power is tracking unstable, which is generated by utilizing natural energies such as wind or solar energy, in real time by applying an automatic tuning algorithm to an energy storage system which is applied to a smart grid or a micro grid that uses renewable energy as a primary energy source.

### BACKGROUND OF THE INVENTION

1. Field of the Invention

The present invention relates to an automatic tuning method for an energy storage system of the railway vehicle. More particularly, the railway vehicle performs the automatic tuning for optimum operation, while it is undergoing the voltage fluctuation of the substations, the voltage variations due to the traffic volume, the wire voltage fluctuation due to the demand variation of power on the hourly basis. The energy storage system of the railway vehicle is designed to be maximizing in the efficiency of operation and maximizing the energy storing capacity.

2. Related Prior Art

The worldwide industrialization has rapidly increased the oil consumption. As a result, our environment has changed. Due to increase the pollutants in our environment, the world's climate has rapidly warmed. To make the matter worse, the natural resources, such as the fossil fuel energy in the world is becoming depleted. Thus, the depletion of the natural resources is caused to raise the oil price steeply. Because the escalation of oil consumption causes to increase the carbon-dioxide in our atmosphere, the Kyoto protocol was established to prevent the global warming. As the urgent project, the research has performed for recycling the energy to reduce the emission of carbon monoxide.

Under such circumstances, the natural energy, such as a wind, tide, solar, or water energy has investigated for utilizing in our life. The new technology has developed to utilize the natural energy for applying in our life. However, the new technology has intensively developed to increase the efficiency. The conventional energy generation device and the storage systems have innovated to improve the certain problems of energy loss for minimizing the loss rate.

In a modern subway, some of trains employ a regeneration brake system to save energy. When the subway train is decelerated, the regeneration brake system converts kinetic energy to the electrical energy and accumulates the converted electric energy. The regeneration brake system is not only reducing the power consumption of the entire system, but also preventing the noise generation by the frictions of brake and wearing of the brake shoes. Regeneration brake system has increasingly applied to the modern train because of such an advantage.

However, when an accelerated train decelerates in a regenerative braking manner in order to stop, the train generates high voltage (i.e., high regenerative power) since a motor of the train operates as a generator to perform regenerative braking. Such regenerated power instantaneously applies high voltage to the overhead line, causing variation in overhead line voltage. This may not only make the system unstable but may also cause a malfunction of a subsequent train when the subsequent train cannot deal with such a high voltage.

Charging and discharging levels of the energy storage system serve as important factors to efficiently utilize regenerative energy. However, it is difficult to efficiently utilize the system due to changes in overhead line voltage according to train operation and changes in subway substation output voltage.

Overhead line voltage variation of a conventional DC subway substation is described in more details with reference to FIG. 1.

A substation facility provided in a power supply system of a DC subway substation includes a 2500 kW 12-pulse rectifier which has a function to convert AC power to DC power. The following Table 1 shows rectifier rating of a substation facility.

From overhead line variation of a DC substation in Table 1, it can be seen that variation in overhead line power generated by a transformer and a rectifier in a DC subway substation system is determined by variation in power supplied by Korea Electric Power Corporation (KEPCO). Up to 3% variation in power supplied by KEPCO is permitted. Actual measurement results showed that overhead line voltage of the output side of the rectifier varies within a range of 1612V to 1640V centering on 1625V without any uniform pattern.

TABLE 1

| List | Voltage |
|---|---|
| Rated DC voltage | 1500 V |
| Secondary voltage of transformer for rectifier | 600 V |
| Voltage coefficient of 3-phase full-wave rectifier | 1.35 |
| Secondary Voltage of rectifier | 810 V |
| Secondary voltage of 12-pulse rectifier | 1620 V |

FIG. 1 illustrates measurement results of a source line at the output side of the rectifier using a DCPT when a train runs. From thick measurement outlines in FIG. 1, it can be seen that overhead line voltage fluctuates regardless of operation of the train. Here, measured voltages peak upon powering up and regenerative braking of the train.

Under the assumption that the overhead line voltage is constant, a general energy storage system is set to perform charging or discharging when voltage measured is higher or less than the overhead line voltage by a predetermined level. However, it is very difficult to set a discharging start voltage, at which the energy storage apparatus begins to perform discharging, to a specific level in a current environment in which a reduction in overhead line voltage when powering up the train is very small as substation facility capacity has increased.

In addition, while voltage reduction when powering up the train is 15V, the overhead line voltage changes by more than 30V, which may hinder smooth charging and discharging of the energy storage apparatus. Therefore, there is a need to change charging and discharging start voltages and charging and discharging maintenance voltages of the energy storage apparatus according to variation in the overhead line voltage. However, it is very difficult to track (or determine) overhead line voltage changes since the overhead line voltage does not vary in a specific pattern based on time or train operation.

Overhead line voltage varies not only according to substation voltage variation or operation pattern variation but also according to time. 22.9 kV power received from a KEPCO power distribution line is supplied as overhead line power via a 12-phase transformer and rectifier. The 22.9 kV power is supplied with a variation of 3%, which exerts an influence upon DC overhead line power of the substation. Therefore, there is a need to appropriately compensate for such overhead line power variation. FIG. 2 shows results of normalization of each time zone of data measured in Daedong substation of Daejeon urban railway Line 1. As shown in FIG. 2, overhead line voltage varies in a range of about 1610V to 1630V.

Similarly, such power variation also makes it very difficult to track (or determine) overhead line voltage changes to increase efficiency of the energy storage system.

### SUMMARY OF THE INVENTION

Therefore, the present invention has been made in view of the above problems, and it is an object of the present invention to provide an automatic tuning method based on an energy storage system for railway trains, wherein optimal tracking of changes in overhead line voltage, which varies with time and according to substation voltage variation and a train operation pattern, is automatically performed to maximize energy storage efficiency.

In accordance with the present invention, the above and other objects can be accomplished by the provision of an automatic tuning method based on an energy storage system for railway trains, the automatic tuning method including a first process in which an energy storage apparatus for railway trains starts operation, a second process in which initial charging of supercapacitors in the energy storage apparatus is completed and a power mode is activated, a third process in which one of a charging mode or a discharging mode is selected, a fourth process in which a power charging or discharging mode is initiated or the energy storage apparatus stops operation, a fifth process in which whether or not a condition for switching between the charging and discharging modes is satisfied is determined, a sixth process in which the charging and discharging modes are switched upon determining that the condition for switching between the charging and discharging modes is satisfied, a seventh process in which whether or not a condition for voltage maintenance or automatic tuning is satisfied is determined, and an eighth process in which a process for voltage maintenance or automatic tuning is performed.

Preferably, the third process includes a process in which the energy storage apparatus stops operation when power supply voltage is lower or higher than a charging start voltage, a process in which whether or not the power supply voltage is higher than the charging start voltage is determined, a process in which power-mode charging is initiated when the power supply voltage is higher than the charging start voltage, a process in which whether or not the power supply voltage is higher than a discharging start voltage is determined, and a process in which power-mode discharging is initiated when the power supply voltage is higher than the discharging start voltage.

Preferably, the fourth process further includes a process in which whether or not a supercapacitor charging or discharging voltage is higher than a charging or discharging limit voltage is determined, and a process in which system charging or discharging is blocked when the supercapacitor charging or discharging voltage is higher than the charging or discharging limit voltage.

Preferably, the fifth process includes switching from a current mode to the discharging mode when a discharging start operation time in the charging mode is longer than 10 s, and switching from the current mode to the charging mode when a charging start operation time in the discharging mode is shorter than 10 s.

Preferably, the seventh process includes a process in which whether or not an actual discharging start voltage in the charging mode is greater than or equal to a discharging limit voltage for automatic level tuning is determined, and a process in which whether or not an actual charging start voltage in the discharging mode is greater than or equal to a charging limit voltage for automatic level tuning is determined.

Preferably, the eighth process includes a process in which the actual discharging start voltage is set as a discharging limit voltage for automatic level tuning when the actual discharging start voltage in the charging mode is greater than or equal to the discharging limit voltage for automatic level tuning, a process in which the discharging start voltage is updated to a higher level when the actual discharging start voltage is less than the discharging limit voltage for automatic level tuning, a process in which the actual charging start voltage is set as a charging limit voltage for automatic level tuning when the actual charging start voltage in the discharging mode is less than or equal to the charging limit voltage for automatic level tuning, and a process in which the discharging start voltage is updated to a lower level when the actual charging start voltage is higher than the charging limit voltage for automatic level tuning.

The automatic tuning method based on the energy storage system for railway trains according to the present invention has a variety of advantages. For example, it is possible to achieve optimal energy saving effects using a bidirectional DC/DC converter which can efficiently use regenerative energy of DC urban railways and can accomplish stabilization of overhead line voltage. In addition, energy efficiency is maximized by charging and discharging energy while tracking unstable power, which is generated using renewable energy such as wind and solar energy, in real time by applying an automatic tuning algorithm to an energy storage system which is applied to a smart grid or a micro grid that uses renewable energy as a primary energy source.

### BRIEF DESCRIPTION OF THE DRAWINGS

FIG. 1 illustrates changes in overhead line voltage when a conventional energy storage system is used.

FIG. 2 illustrates changes in overhead line voltage with time when a conventional energy storage system is used.

FIG. 3 is a circuit diagram of an energy storage apparatus for railway trains according to an embodiment of the present invention.

FIG. 4 illustrates a simplified configuration of a power mode controller which is applied to an energy storage system for railway trains according to an embodiment of the present invention.

FIG. 5 is a flowchart illustrating automatic tuning based on the energy storage system for railway trains according to an embodiment of the present invention.

FIG. 6 is an operation test diagram illustrating an over-discharging state when automatic tuning based on the energy storage system for railway trains according to an embodiment of the present invention is not applied.

FIG. 7 is an operation test diagram illustrating over-charging state when automatic tuning based on the energy storage system for railway trains according to an embodiment of the present invention is not applied.

FIG. 8 is a test diagram illustrating operation states when automatic tuning based on the energy storage system for railway trains according to an embodiment of the present invention is applied.

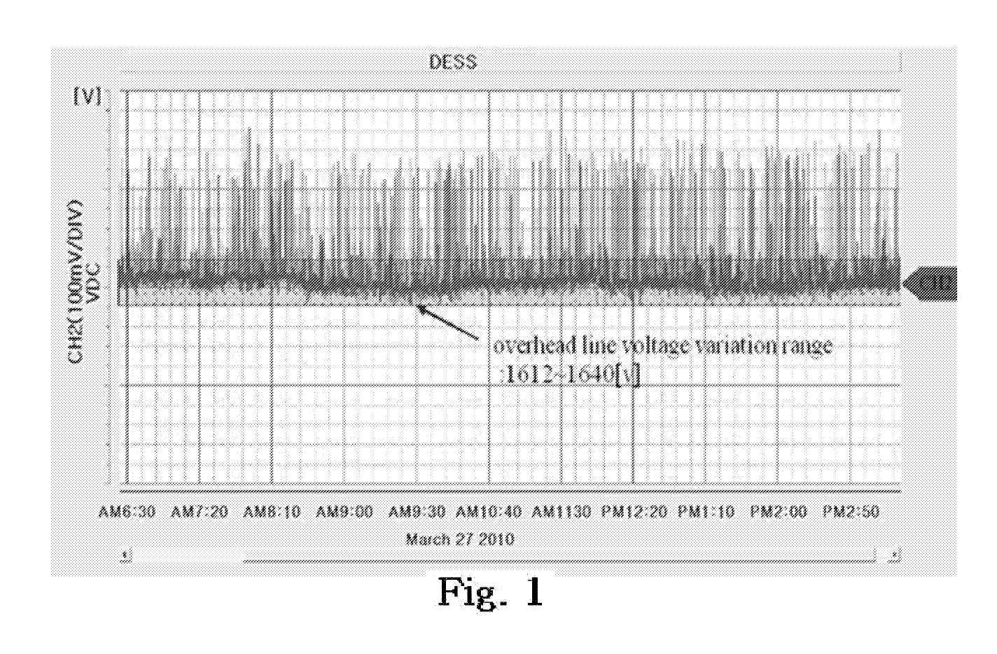

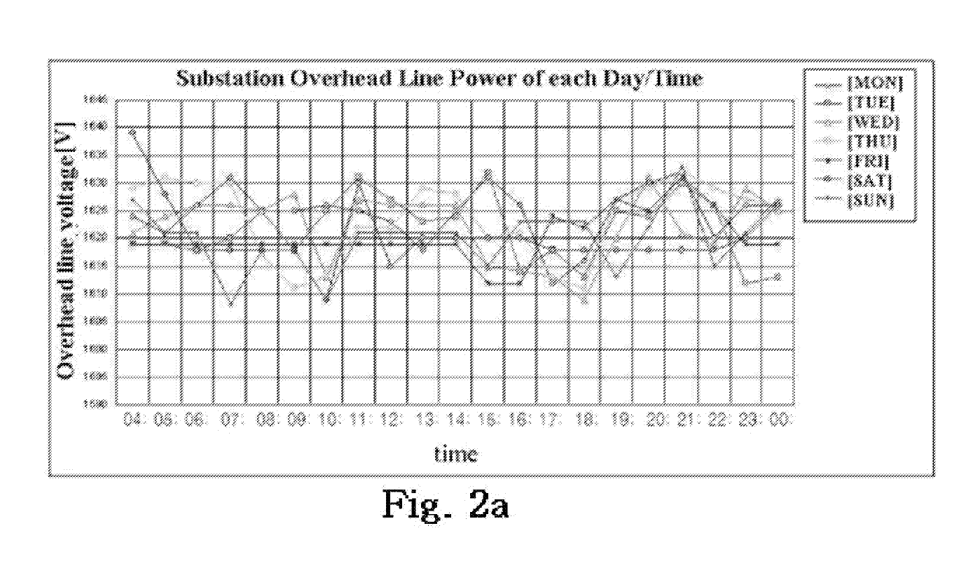

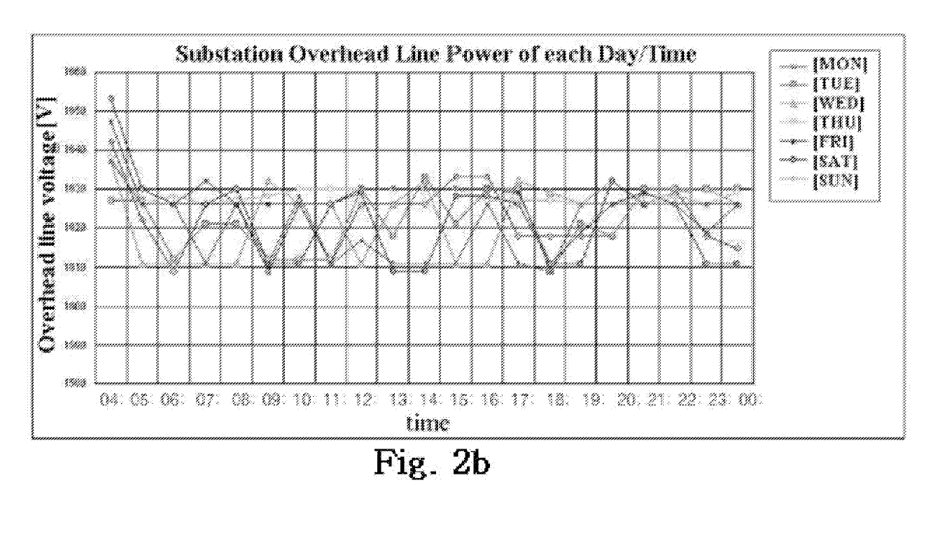

### DETAILED DESCRIPTION OF THE PREFERRED EMBODIMENT

Embodiments of the present invention will now be described in detail with reference to the drawings.

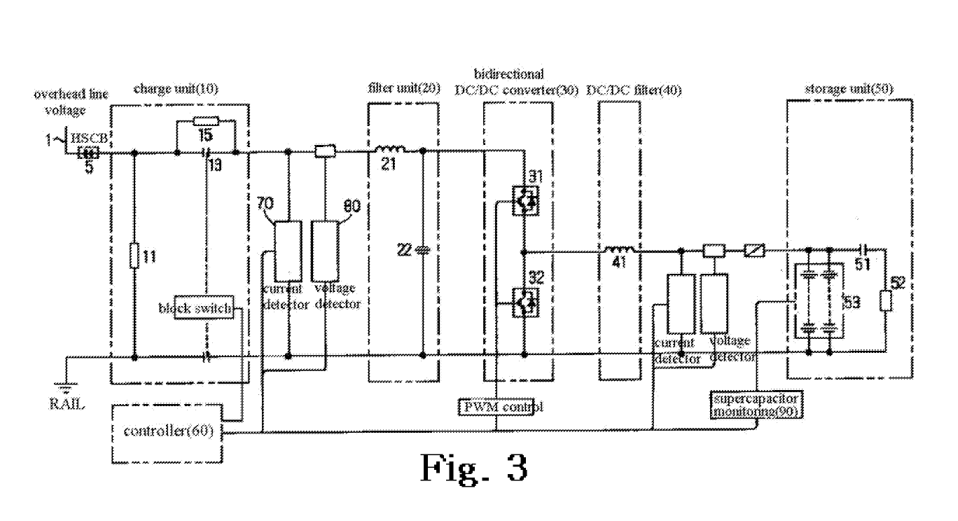

FIG. 3 is a circuit diagram of an energy storage apparatus for railway trains according to an embodiment of the present invention.

In an automatic tuning method based on an energy storage system for railway trains according to the embodiment of the present invention, optimal tracking of changes in overhead line voltage, which varies with time and according to substation voltage variation and a train operation pattern, is automatically performed to maximize energy storage efficiency.

Hereinafter, an electric dual layer capacitor is referred to as an EDLC for short.

The energy storage apparatus according to a preferred embodiment of the present invention includes a charging unit 10, a filter unit 20, a bidirectional DC/DC converter 30, a DC/DC filter 40, a storage unit 50, a controller 60, a current detector 70, and a voltage detector 80.

Since the bidirectional DC/DC converter 30 self-oscillates at high frequencies in a range of tens of kHz to hundreds of kHz to increase or decrease voltage, there is a need to provide a filter to prevent high frequency noise generated by transistors, FETs, or the like from being output through input and output power lines.

Although the filter unit 20 includes an inductor 21 that is connected in series to the circuit of the energy storage apparatus and a capacitor 22 that is connected in parallel to the circuit in this embodiment, the filter unit 20 may be replaced with any equivalent circuit which removes high frequency noise.

According to a preferred embodiment, the filter unit 20 which serves to block passage of high frequency noise includes a capacitor. A small-capacitance capacitor causes no significant problem since it takes a long time to fully charging the capacitor. However, a large-capacitance capacitor has a risk of causing excess current since the capacitor is almost equivalent to a short circuit until the capacitor is charging to some extent such that the amount of current flowing through the capacitor is reduced below a certain level. Since such excess current may cause significant problems in a neighbor system, the energy storage apparatus needs to include a protective circuit. The charging unit 10 serves as such a protective circuit.

When the charging switch 13 is off, a resistor 15 of the charging unit 10 prevents excess current from flowing. The charging switch 13 is turned on after the capacitor 22 is fully charging.

Impedance 11 of the charging unit 10 serves to achieve circuit impedance matching and may be selected as needed. A block switch 12 serves to block power in the system, separately from a fast blocker 5.

The bidirectional DC/DC converter 30 bidirectional converts a DC voltage to a specific DC voltage while switching a first transistor 31 and a second transistor 32 through Pulse Width Modulation (PWM) control. Capacitors 33 and 34 are provided in parallel for the first transistor 31 and the second transistor 32 to prevent an increase in current spike that may occur when the transistors switch on and off at a high frequency in a range of tens of KHz to hundreds of KHz. The bidirectional DC/DC converter 30 operates as a buck converter when the first transistor 31 is on and the second transistor 32 is off and operates as a boost converter when the first transistor 31 is off and the second transistor 32 is on. Here, it is preferable that the first transistor and the second transistor be controlled with a phase difference of 180 degrees in order to control bidirectional power flow. In this case, the second transistor serves as a main switch.

The DC/DC filter 40 prevents a number of problems from occurring due to high frequency noise that flows into neighbor devices as described above with reference to the filter unit 20. Although an inductor 41 is used as the DC/DC filter 40 in this embodiment, the inductor 41 may be replaced with any other circuit that functions the same as the DC/DC filter 40.

The storage unit 50 includes a number of EDLCs 53 that are connected in parallel and store regenerative power that is received through the bidirectional DC/DC converter 30. A storage time of the storage unit 50 is determined according to the capacitance of the capacitor.

The storage unit 50 includes a switch 51 and a resistor 52 that are used to forcibly (or manually) consume power stored in the capacitor.

The current detector 70 measures current flowing into the filter unit 20 and outputs the measured current to the controller 60 and the voltage detector 80 measures voltage applied across both ends of the capacitor 22 of the filter unit 20 (i.e., voltage of an overhead line 1) and outputs the measured voltage to the controller 60. The supercapacitor monitoring unit 90 measures the voltage and the charging level of the EDLCs 53 and output the same to the controller 60. The supercapacitor monitoring unit 90 measures the voltage, charging level, and the like of the EDLCs 53 of the storage unit 50 and outputs the same to the controller 60.

The controller 60 may include a microprocessor or a general computer system.

A reference voltage that is applied to urban railway, subway, or light-rail trains in Korea is mostly 1500V or 750V. A reference voltage for storing regenerative power is set to be higher than the applied voltage and a reference voltage for supplying regenerative power back to the overhead line is set to be less than the applied voltage. For example, the controller 60 is configured as follows when the applied voltage is set to 1500V, the reference voltage for storing regenerative power is set to 1800V which is higher than the applied voltage, and the reference voltage for supplying regenerative power is set to 1000V which is less than the applied voltage.

The controller 60 receives the measured voltage of the overhead line 1 from the voltage detector 80 and outputs a control signal for switching the first transistor 31 on to switch the operating mode to a charging mode when the measured voltage of the overhead line 1 is equal to or higher than 1800V. Here, the bidirectional DC/DC converter 30 operates as a buck converter.

When the measured voltage of the overhead line 1 is equal to or less than 1000V, the controller 60 outputs a control signal for switching the first transistor 31 off and switching the second transistor 32 on. Here, the bidirectional DC/DC converter 30 operates as a boost converter.

In this embodiment, the controller 60 outputs a control signal according to a PWM scheme. A detailed description of the PWM control method is omitted herein since it is well known in the art.

In the case in which the supercapacitor monitoring unit 90 outputs a signal indicating that the storage unit 50 is fully charging, the operating mode is not switched to the charging mode even when the overhead line voltage is equal to or higher than 1800V which is the reference voltage for regenerative power storage and the operating mode is not switched to the power supply mode when the voltage of the storage unit 50 measured by the supercapacitor monitoring unit 90 is equal to or less than 1000V which is the reference voltage for regenerative power supply.

The controller 60 of the energy storage system for railway trains according to an embodiment of the present invention includes an initial charging controller for initial constant-current charging of supercapacitors and a power controller 110 for stabilizing overhead line power using regenerative energy that is generated upon powering up or braking of the train after initial charging is completed. Each of the initial charging controller and the power controller 110 is designed as a PI-PI dual loop controller.

As a controller for initially charging supercapacitors, the initial charging controller includes a soft start controller for preventing surge current according to a dv/dt component when the supercapacitors have been fully discharging, a current controller for constant-current control, and a voltage controller for controlling duty ratio according to an output value from the current controller.

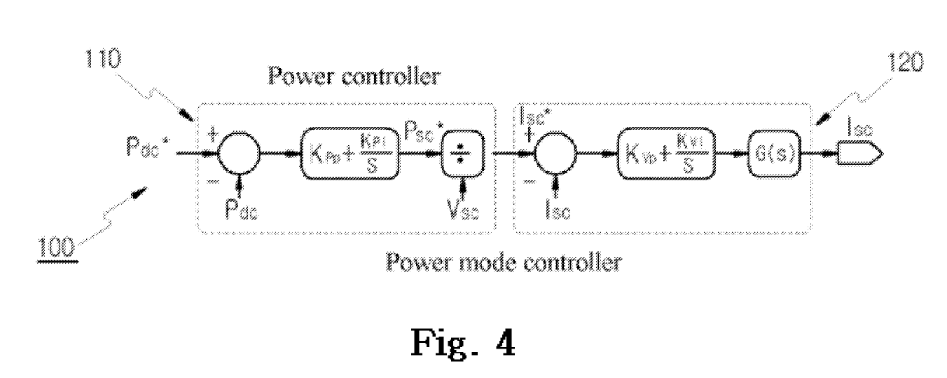

FIG. 4 illustrates a simplified configuration of a power mode controller to which the present invention is applied. In a power mode, the current controller 120 is present in an inner loop unlike in an initial charging mode and has a break frequency higher than that of the power controller 110 which is present in an outer loop.

In the power mode, the power controller 110, which is present in the outer loop, controls power of the DC link terminal such that an actual impedance value of the DC link terminal matches a target impedance value thereof to compensate for an error value.

A system transfer function of the power controller 110 is calculated as shown in Equation (2) using a relation of Equation (1).

$$\begin{matrix}{P}_{d c} \# {P}_{sc} = \frac{1}{2} {C}_{sc} {V}_{sc}^{2} = {V}_{sc} {I}_{sc} ; & ( Equation 1 ) \\ G ( s ) = \frac{{P}_{sc} ( s )}{{I}_{sc} ( s )} = {V}_{sc} ( s ) = \frac{1}{{sC}_{sc}} ; & ( Equation 2 )\end{matrix}$$

Functions and operations of the energy storage system for railway trains according to an embodiment of the present invention are described below in detail with reference to the drawings.

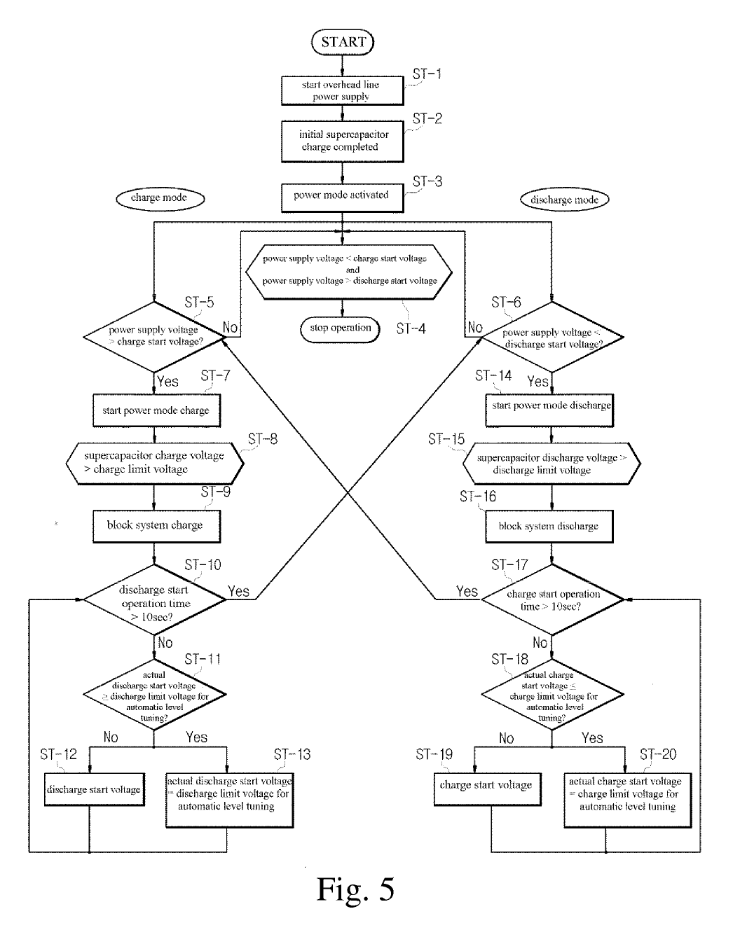

FIG. 5 is a flowchart illustrating automatic tuning based on the energy storage system for railway trains according to an embodiment of the present invention.

Generally, the energy storage system and controller have been designed initially based on a home environment in which overhead line power is uniform. However, practically, such an ideal overhead line condition does not exist anywhere in the world. That is, when charging and discharging are performed, it is necessary to take into consideration the range of variation of overhead line voltage and variation of charging and discharging start and maintenance voltages due to such overhead line voltage variation.

Variation of the output voltage of the substation rectifier needs to be closely analyzed and the energy storage system should not be charging with substation power. In addition, an excessively high discharging start voltage should not be selected for normal or regular discharging.

If the charging and discharging start voltages of the energy storage system are fixed, the amount of discharging of supercapacitors may become larger or smaller than the amount of charging of supercapacitors according to variation of substation power and train operation such that the supercapacitors are in an excessive charging or discharging state, resulting in a reduction in energy saving efficiency.

Because of this, there is a need to provide automatic tuning based on an energy storage system for railway trains according to the embodiment of the present invention. In the automatic tuning method for the energy storage system for railway trains according to the embodiment of the present invention, charging and discharging start voltages of the energy storage system are not fixed to specific levels while the overhead line voltages are monitored in real time and changes of the overhead line voltages are applied to control such various voltages in an associated manner.

Specifically, when a power mode is activated upon completion of initial charging of supercapacitors after overhead line begins to supply power, the energy storage system for railway trains according to an embodiment of the present invention compares charging and discharging start voltages with the power supply voltage and increases or decreases the charging and discharging start voltages in a stepwise manner and starts charging and discharging at the increased or decreased charging and discharging start voltages.

More specifically, the automatic tuning method based on the energy storage system for railway trains according to an embodiment of the present invention includes a first process in which the energy storage apparatus for railway trains starts operation, a second process in which initial charging of supercapacitors in the energy storage apparatus is completed and a power mode is activated, a third process in which one of a charging mode or a discharging mode is selected, a fourth process in which a power charging or discharging mode is initiated or the energy storage apparatus stops operation, a fifth process in which whether or not a condition for switching between the charging and discharging modes is satisfied is determined, a sixth process in which the charging and discharging modes are switched upon determining that the condition for switching between the charging and discharging modes is satisfied, a seventh process in which whether or not a condition for voltage maintenance or automatic tuning is satisfied is determined upon determining that the condition for switching between the charging and discharging modes is not satisfied, and an eighth process in which a voltage maintenance or automatic tuning process is performed.

Here, the third process includes process ST-4 in which the energy storage apparatus stops operation when power supply voltage is lower or higher than the charging start voltage, process ST-5 in which whether or not the power supply voltage is higher than the charging start voltage is determined, process ST-7 in which power-mode charging is initiated when the power supply voltage is higher than the charging start voltage, process ST-6 in which whether or not the power supply voltage is higher than a discharging start voltage is determined, and process ST-14 in which power-mode discharging is initiated when the power supply voltage is higher than the discharging start voltage.

The fourth process further includes process ST-8 or ST-15 in which whether or not a supercapacitor charging or discharging voltage is higher than a charging or discharging limit voltage is determined, and process ST-9 or ST-16 in which system charging or discharging is blocked when the supercapacitor charging or discharging voltage is higher than the charging or discharging limit voltage.

The fifth process includes switching from the current mode to the discharging mode when a discharging start operation time in the charging mode is longer than 10 s and switching from the current mode to the charging mode when a charging start operation time in the discharging mode is shorter than 10 s.

The seventh process includes process ST-11 in which whether or not an actual discharging start voltage in the charging mode is greater than or equal to a discharging limit voltage for automatic level tuning is determined and process ST-18 in which whether or not an actual charging start voltage in the discharging mode is greater than or equal to a charging limit voltage for automatic level tuning is determined.

The eighth process includes process ST-13 in which the actual discharging start voltage is set as a discharging limit voltage for automatic level tuning when the actual discharging start voltage in the charging mode is greater than or equal to the discharging limit voltage for automatic level tuning, process ST-12 in which the discharging start voltage is updated to a higher level when the actual discharging start voltage is less than the discharging limit voltage for automatic level tuning, process ST-20 in which the actual charging start voltage is set as a charging limit voltage for automatic level tuning when the actual charging start voltage in the discharging mode is less than or equal to the charging limit voltage for automatic level tuning, and process ST-12 in which the discharging start voltage is updated to a lower level when the actual charging start voltage is higher than the charging limit voltage for automatic level tuning.

As a result, the energy storage system according to the embodiment of the present invention can maximize energy storage system efficiency by increasing the number of times charging and discharging is performed using such an automatic tuning algorithm.

Charging and Discharging Algorithm Used Before Automatic Tuning Scheme is Applied

The charging and discharging algorithm before automatic tuning is applied sets the charging and discharging start voltages, charging and discharging maintenance voltages, and charging and discharging reset voltages to fixed values under the assumption that the overhead line voltage is kept at 1625V when load is not present. Overhead line voltages are measured upon powering up and regenerative braking of the train and such voltages at which charging and discharging can be smoothly performed on average are determined as setting values of the charging and discharging start, maintenance voltage, and reset voltages. For example, setting values of the charging and discharging start, maintenance voltage, and reset voltages are determined as follows.

During Charging

Charging start voltage: non-load overhead line voltage+30V=1655V

Charging reset voltage: non-load overhead line voltage+15V=1640V

Charging maintenance voltage: non-load overhead line voltage+20V=1645V

During Discharging

Discharging start voltage: non-load overhead line voltage−9V=1616V

Discharging reset voltage: non-load overhead line voltage−0V=1625V

Discharging maintenance voltage: non-load overhead line voltage−5V=1620V

Algorithm when Automatic Tuning Scheme is Applied

The algorithm used when automatic tuning is applied (which is also referred to as an automatic tuning algorithm) calculates setting values associated with charging and discharging in the same manner as the algorithm used before the automatic tuning scheme is applied, with the difference being that the automatic tuning algorithm detects a non-load overhead line voltage and applies the non-load overhead line voltage in a varying manner. However, it is very difficult for a processor to detect and determine a non-load overhead line. The current automatic tuning scheme determines a non-load voltage in the following manner. First, an initial non-load voltage is defined as 1625V. If the energy storage apparatus fails to perform discharging for a predetermined time while in an over-charging state, the non-load voltage is increased by 5V every 20 s to enable discharging to be performed even at low powering-up energy (or low consumed energy). Similarly, if the energy storage apparatus fails to perform charging for a predetermined time while in an over-discharging state, the non-load voltage is decreased by 5V every 20 s to enable charging to be performed even with low regenerative (or regenerated) energy. If the non-load voltage is set too high or too low, the energy storage apparatus enters an over-discharging state or an over-charging state and, from such setting values, it is possible to determine a non-load overhead line voltage during charging and discharging.

From actual experiments, we found that a non-load voltage can be estimated through up to 2 tuning processes associated with charging and discharging. We also found that the number of times charging and discharging is performed was increased by about 600 per day on average and power (or voltage) supplied from supercapacitors is increased by about 1.5 times when the same current limit value is applied.

During Charging

Charging start voltage: non-load overhead line voltage+30V=1655V

Charging reset voltage: non-load overhead line voltage+15V=1640V

Charging maintenance voltage: non-load overhead line voltage+20V=1645V

During Discharging

Discharging start voltage: non-load overhead line voltage−9V=1616V

Discharging reset voltage: non-load overhead line voltage−0V=1625V

Discharging maintenance voltage: non-load overhead line voltage−5V=1620V

The following Table 2 illustrates charging and discharging conditions and supercapacitor charging and discharging limit voltages and currents of the energy storage system according to an embodiment of the present invention, where current that can flow into supercapacitors is limited to 200 A.

TABLE 2

| | When automatic | When automatic |
|---|---|---|
| | level tuning | level tuning |
| Classification | is not applied | is applied |
| Charging start voltage | 1660 V | 1645-1660 V |
| Discharging start voltage | 1615 V | 1615-1624 V |
| Supercapacitor over-charging | 1050 V | 1050 A |
| limit voltage | | |
| Supercapacitor | 450 V | 450 A |
| over-discharging limit voltage | | |
| Supercapacitor | 200 V | 200 A |
| charging/discharging current limit | | |

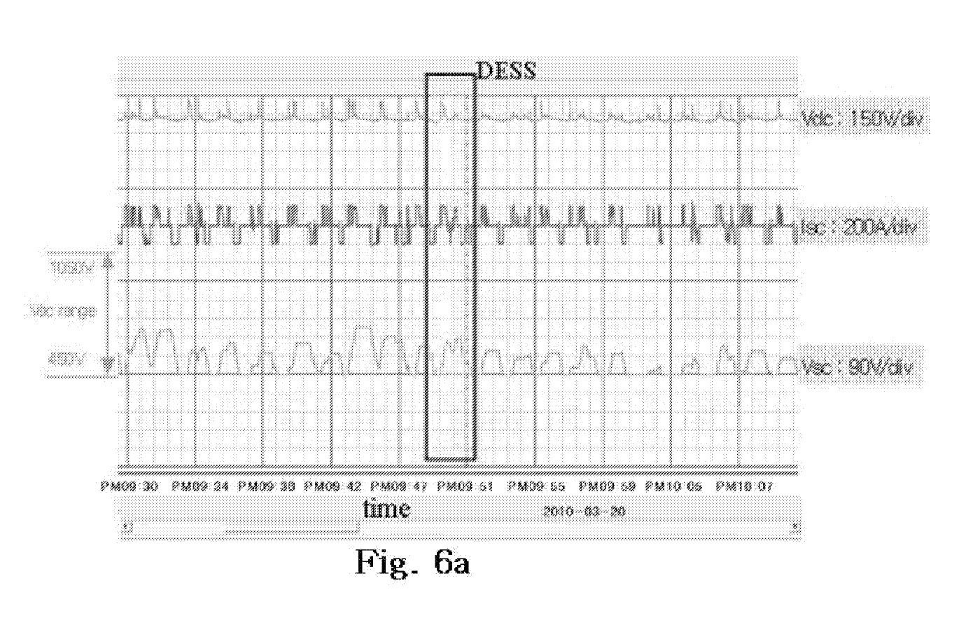

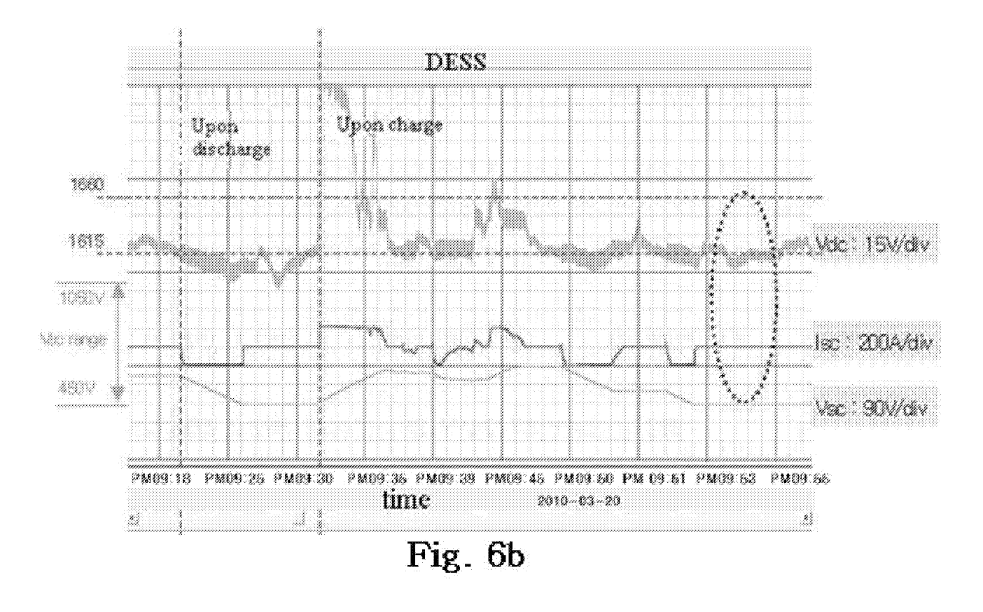

FIG. 6 is an operation test diagram illustrating an over-discharging state when automatic tuning based on the energy storage system for railway trains according to an embodiment of the present invention is not applied.

Specifically, FIG. 6 illustrates charging and discharging waveforms of the energy storage system when automatic tuning is not applied. In the example of FIG. 6, the supercapacitor-side portion of the apparatus operates in an over-discharging region since overall overhead line voltage is low. As can be seen from enlarged waveforms in FIG. 6, after the supercapacitor over-discharging level of 450V is reached, discharging is not performed even after the overhead line voltage reaches 1615V which is the discharging start voltage. This occurs when the apparatus operates while the normal overhead line voltage is low.

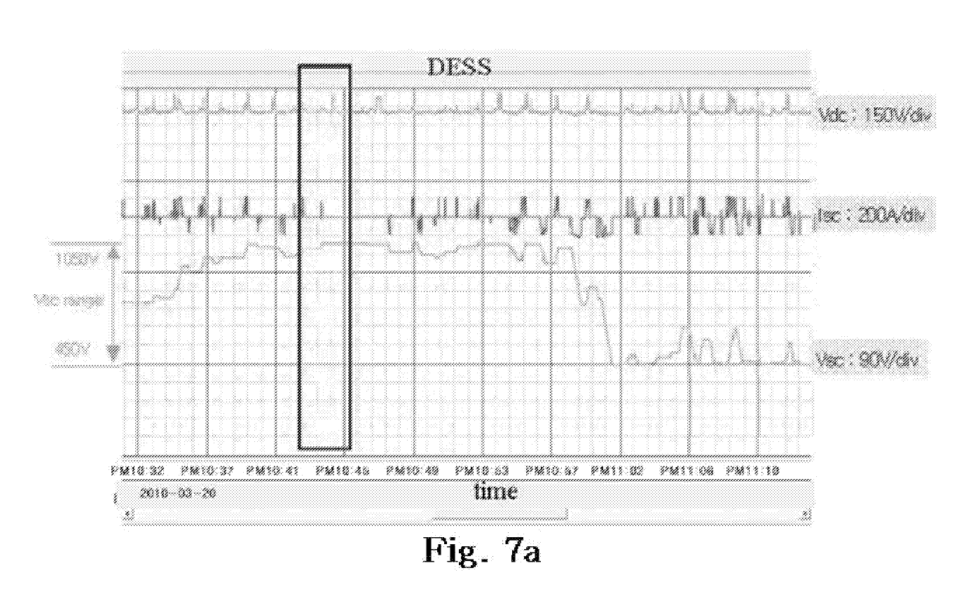

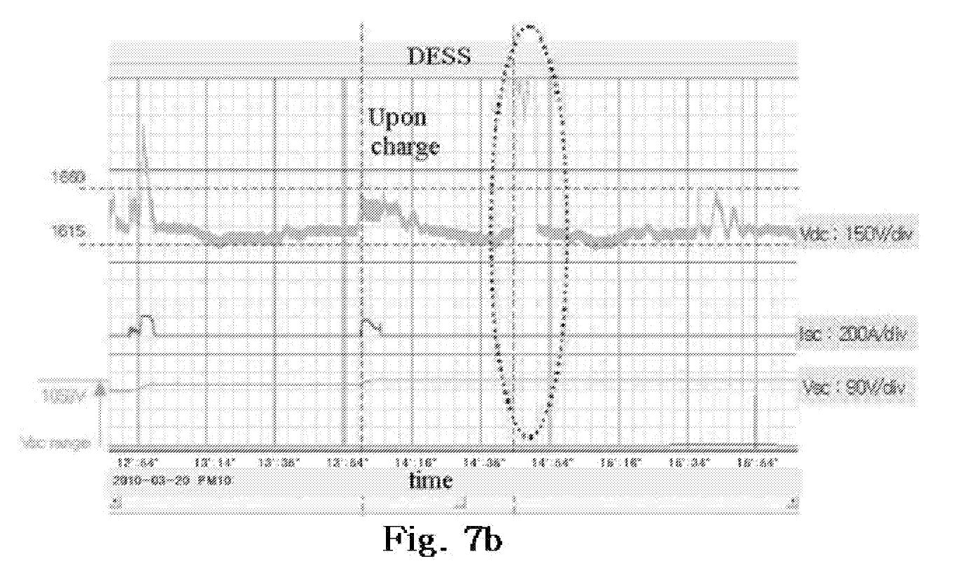

FIG. 7 is an operation test diagram illustrating an over-charging state when automatic tuning based on the energy storage system for railway trains according to an embodiment of the present invention is not applied.

Specifically, FIG. 7 illustrates charging and discharging waveforms of the energy storage system when automatic tuning is not applied. In the example of FIG. 7, the supercapacitor-side portion of the apparatus operates in an over-charging region since overall overhead line voltage is high. As can be seen from enlarged waveforms in FIG. 7, charging starts when the overhead line voltage exceeds 1660V which is the charging start voltage.

However, since the normal overhead line voltage is high, after the overhead line voltage reaches the supercapacitor over-charging level 1050V, the overhead line voltage does not drop below the discharging start voltage 1615V such that discharging is not performed even upon powering up of the train. Accordingly, it can be seen that, even when regenerative power is generated, the regenerative power cannot be used to perform charging until the overhead line voltage is reduced below the discharging start voltage according to variation of substation output or train operation.

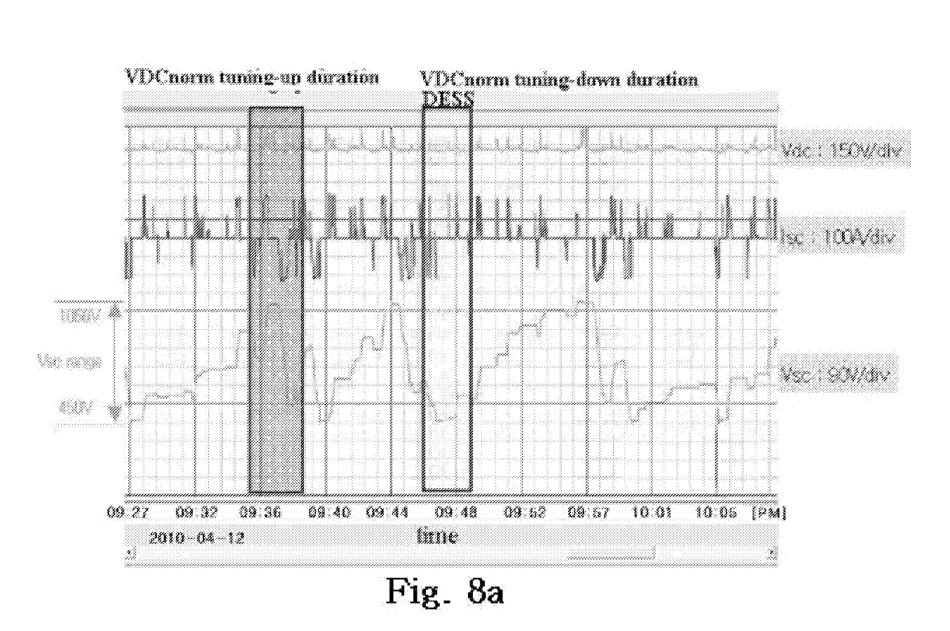

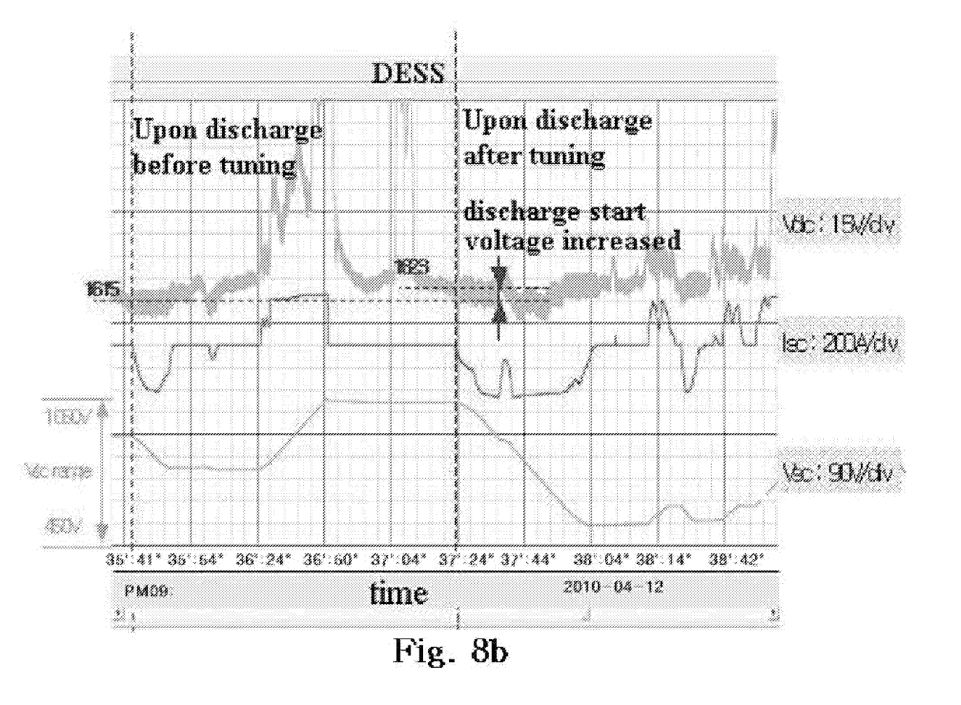

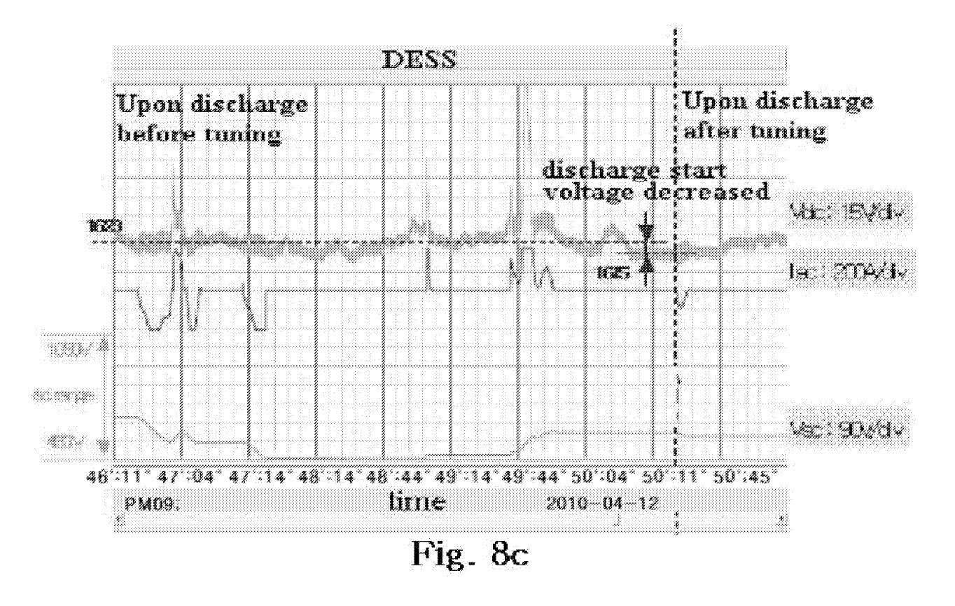

FIG. 8 is a test diagram illustrating operation states when automatic tuning based on the energy storage system for railway trains according to an embodiment of the present invention is applied.

Specifically, FIG. 8 illustrates waveforms when an automatic charging and discharging level tuning algorithm is applied. As can be seen from enlarged waveforms in FIG. 8, if a charging operation is not performed for a predetermined time while the supercapacitors are in an over-discharging state according to variation of substation output and train operation, it is determined that the normal overhead line voltage is low and the charging start voltage is increased in a stepwise manner and charging starts at the increased charging start voltage.

On the other hand, if a discharging operation is not performed for a predetermined time while the supercapacitors are in an over-charging state, it is determined that the normal overhead line voltage is high and the discharging start voltage is increased in a stepwise manner and discharging starts at the increased charging start voltage.

The energy storage system for railway trains according to the embodiments of the present invention is expected to improve the effects of a reduction in power costs of an urban railway operation institution using regenerative energy in the current high-oil price environment while achieving advantages such as stabilization of subway substation facility and overhead line power, a reduction in peak power, and a reduction in CO2 gas emissions.

The present invention suggests an automatic charging and discharging level tuning algorithm which can achieve optimal energy reduction effects using a bidirectional DC/DC converter which can efficiently use regenerative energy of DC urban railways and can accomplish stabilization of overhead line voltage. We experimentally analyzed and proved the effects of the suggested method by applying the suggested method to a substation system of Daejeon urban railway Line 1 which is an actual DC urban railway system.

The present invention is also expected to maximize energy efficiency by charging and discharging energy while tracking unstable power, which is generated using renewable energy such as wind and solar energy, in real time by applying an automatic tuning algorithm to an energy storage system which is applied to a smart grid or a micro grid that uses renewable energy as a primary energy source.

The automatic tuning method based on an energy storage system for railway trains according to the present invention is not limited to the above embodiments and may be modified in various ways without departing from the spirit of the present invention.

What is claimed is:

1. An automatic tuning method for an energy storage system of railway vehicles, the method is comprising the steps of:
(1) operating the energy storage apparatus of the railway trains;
(2) completing an initial-charging of the supercapacitors in the energy storage apparatus and activating a power mode;
(3) selecting either one of charging mode or discharging mode;
(4) stopping the initial power charging/discharging modes and the energy storage apparatus;
(5) determining whether the condition of initial operation is satisfied for switching between charging mode and discharging mode;
(6) switching the charging/discharging modes according to the determined condition and operating the switched mode of the charging/discharging;
(7) determining whether the operating condition is satisfied the voltage maintenance or automatic tuning; and
(8) performing either one of the voltage maintenance or automatic tuning.

2. The automatic tuning method according to claim 1, wherein the third process is further comprising:
stopping the operation of the energy storage apparatus, when the operating power voltage is lower or higher than a starting charging voltage;
determining the supplying voltage, whether the power voltage is higher than the starting charging voltage;
initiating the power charging mode when the power supply voltage is higher than the start charging voltage;
determining the power supplying voltage, whether it is higher than a start discharging voltage; and
initiating the power discharging mode when the power supplying voltage is higher than the start discharging voltage.

3. The automatic tuning method according to claim 1, wherein the fourth process is further comprising:
determining whether a charging or discharging voltage of supercapacitor is higher than a limited charging or discharging voltage; and
blocking charging or discharging when the supercapacitor charging or discharging voltage is higher than the limited charging or discharging voltage.

4. The automatic tuning method according to claim 1, wherein the fifth process is further comprising:
switching from the current operating mode to the discharging mode when the start discharging operation time in the charging mode is longer than ten seconds; and
switching from the current operating mode to the charging mode when the start charging operation time in the discharging mode is shorter than ten seconds.

5. The automatic tuning method according to claim 1, wherein the seventh process is further comprising:
determining an actual start discharging voltage in the charging mode whether it is greater than or equal to the limited discharging voltage for automatic level tuning; and
determining an actual start charging voltage in the discharging mode whether it is greater than or equal to the limited charging voltage for automatic level tuning.

6. The automatic tuning method according to claim 1, wherein the eighth process is further comprising:
setting an actual start discharging voltage as a limited discharging voltage for automatic level tuning when the actual start discharging voltage in the charging mode is greater than or equal to the limited discharging voltage for automatic level tuning;
updating the start discharging voltage to a higher level when the actual start discharging voltage is less than the limited discharging voltage for automatic level tuning;
setting the actual start charging voltage as the limited charging voltage for automatic level tuning when the actual start charging voltage in the discharging mode is less than or equal to the limited charging voltage for automatic level tuning; and
updating the start discharging voltage to a lower level when the actual start charging voltage is higher than the limited charging voltage for automatic level tuning.
